(19) United States
(12) Patent Application Publication
(10) Pub. No.: US 2005/0262972 A1
(43) Pub. Date: Dec. 1, 2005

(54) Wrench, adjustable with locking plate

(76) Inventor: John Tedrick, Tulsa, OK (US)

Correspondence Address: John Tedrick, 4937 S. 86th E. Avenue, Tulsa, OK, 74145, US

(21) Appl. No.: 11/193,676

(22) Filed: Aug. 1, 2005

Related U.S. Application Data
(63) Continuation-in-part of application No. 10/795,855, filed on Mar. 9, 2004, now Pat. No. 6,951,157.

(51) Int. Cl. B25B 13/16

(52) U.S. Cl. 81/165

(57) ABSTRACT

Adjustable wrenches have been in use for more than 100 years. They have been “slipping out of adjustment” for the same time frame. Many solutions to this problem have been proposed, some have been patented. This is a possible solution to the problem.

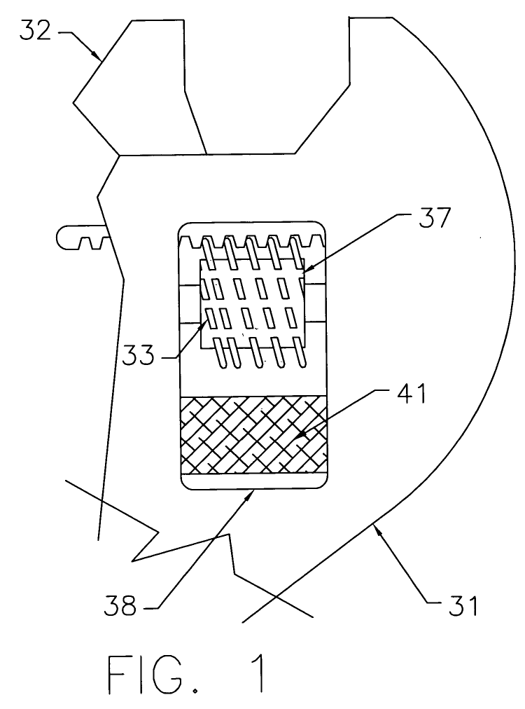

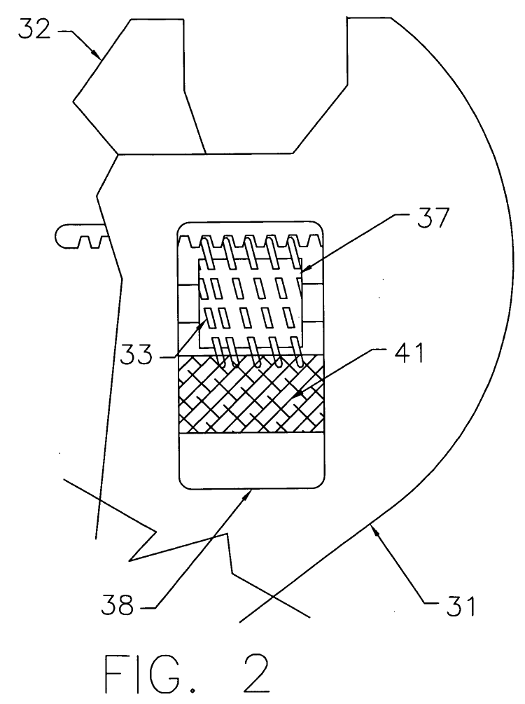

### BACKGROUND OF THE INVENTION

1. Field of the Invention

This application is a continuation-in-part of application Ser. No. 10/795,855. This invention relates in general to a wrench, and in particular, to a parallel, slidable jaw wrench used to tighten or loosen nuts, bolts, valve steams, or items requiring turring. Adjustable wrenches have been used for many years and are still in use today. Most mechanics, machinist, millwrights, plumbers, and electricians have this wrench in their tool box.

The wrench in its present configuration is entirely suitable for casual use. However, for extended use, doing a job repeatedly, a device for locking the adjustment would be desirable.

2. Description of Related Art

While making a patent search I have found a number of adjustable wrench patents with some form of locking device. Such as;

Keller U.S. Pat. No. 1,444,793, Swanstrom U.S. Pat. No. 2,849,908, Lindgran U.S. Pat. No. 3,857,308, Spector U.S. Pat. No. 5,222,419, Haskell U.S. Pat. No. 5,540,125, Gustafson U.S. Pat. No. 5,644,957.

None of these inventors use a locking method such as I have shown in this invention.

### DESCRIPTION OF THE INVENTION

An adjustable wrench comprising a body having a handle, a fixed jaw (31), a moveable jaw (32) having a guiding flange and rack gear, a bore having a slot to accept the moveable jaw, a window (38) to accept a rotable worm (33) and locking plate (41), a rotable worm having threads to mate with said moveable jaw rack gear, said worm being held in said window by the worm shaft, and mating with said moveable jaw rack gear, said worm having one or more arrays of notches (37) milled across the circumference, said locking plate may be slid into one array of notches to prevent rotation of said worm gear.

### DESCRIPTION OF THE DRAWINGS

FIG. (1) is a plan view of the wrench sowing the moveable jaw in the open position. The locking plate is shown in the unlocked position.

FIG. (2) is a plan view of the wrench showing the moveable jaw in the open position. The locking plate is shown in the locked position.

1. An anti-drift improvement for an adjustable wrench having a moveable jaw with rack gear driven by a worm gear. Said worm gear mounted in a window made in the wrench body, the improvement comprising; a flat plate is added in the lower portion of said window, retained in place but slideable within a groove cut into each side of the window; the teeth of said worm gear having an array of notches extending parallel to the bore of said gear, when one of the array of notches is correctly positioned the plate may be slid into the notches to prevent rotation of the said worm gear.
